(19) United States
(12) Patent Application Publication
(10) Pub. No.: US 2016/0016327 A1
(43) Pub. Date: Jan. 21, 2016

(54) DIE CUTTING

(71) Applicants: Vanessa Seal, Dartford (GB); Alan Seal, Dartford (GB)

(72) Inventor: Vanessa Seal, Dartford (GB)

(21) Appl. No.: 14/799,398

(22) Filed: Jul. 14, 2015

(30) Foreign Application Priority Data
Jul. 16, 2014 (GB) 1412632.0

(51) Int. Cl. B26F 1/44; A23P 1/08; B32B 3/26; B32B 3/30; B26F 1/40; B32B 37/10

(52) U.S. Cl. CPC B26F 1/44; B26F 1/40; B32B 37/10; B32B 3/266; B32B 3/30; A23P 1/086; B26F 2001/4481; B32B 2309/105; B32B 2451/00

(57) ABSTRACT

A method of die cutting. The method comprises: providing a cutting die (10); providing a work piece (20) to be cut; providing a first polymer film (30) between the cutting-die (10) and the work piece (20); and pressing the cutting die (10) and the work piece (20) together, with the first polymer film (30) between them, to cut the work piece (20). Also provided is a laminate obtainable by said die cutting method and a kit of parts for use in said die cutting method.

### FIELD OF THE INVENTION

The present invention relates to die cutting. It is particularly relevant to die cutting for use in arts and crafts activities, such as card-making and cake decorating.

### BACKGROUND OF THE INVENTION

Designing and creating home-made greeting-cards has become a popular craft pastime. One technique that is widely used in these card-making craft activities is die cutting. Paper or card stock can be cut into a desired pattern in an accurate and highly reproducible way. The patterned paper or card stock can be used to form the chassis of a greeting card or to decorate a greeting card.

The cutting dies and cutting presses (die cutting machines) used in this process are manufactured and sold commercially. There is a trend towards ever more complex and intricate patterns, with ever finer detail, in order to make the final greeting cards more attractive. However, this trend has brought problems. The patterned piece of paper or card stock (the patterned “work piece”) may be made delicate as a result of the fine patterning that is cut into it. Also, the waste portions or offcuts may adhere to the work piece after the die cutting process. Detaching these unwanted portions from the desired patterned work piece can be difficult and laborious—especially as complex patterns may have many offcut portions. Traditionally, the hobbyist would push these portions out of the work piece one by one, using a stylus.

To make it easier to separate the patterned work piece from the unwanted offcut portions, it has been suggested to apply a layer of wax paper between the cutting die and the work piece, during the die cutting process.

It is also known to use die cutting with sugar-based icing sheets, to create edible decorations (for example, for cakes).

### SUMMARY OF THE INVENTION

According to an aspect of the invention, there is provided a method of die cutting, comprising:

providing a cutting die;

providing a work piece to be cut;

providing a first polymer film between the cutting-die and the work piece; and

pressing the cutting die and the work piece together, with the first polymer film between them, to cut the work piece.

The inventors have found that using a first polymer film in this way can make cutting more effective and/or can make it easier or tidier to release the work piece after cutting. In particular, waste or offcut portions of the material of the work piece may be separated cleanly from the desired patterned work piece. The presence of the first polymer film may help to isolate portions of the work piece on opposing sides of a cut, in the process of die cutting. The offcut portions may then be retained to some extent by the first polymer film, when pulling the first polymer film and the patterned work piece apart, after cutting.

The use of a polymer film has been found to produce better results than using wax paper. In part, this may be because the wax paper is likely to be cut with the work piece, during the die cutting process. In contrast, it seems that a polymer film may deform without being cut or ruptured, even though the work piece is cut and the polymer film is located between the work piece and the cutting edges of the die, during the cutting process.

The cutting die defines a cutting pattern. In turn, the cutting pattern defines the shape of the desired patterned work piece.

The first polymer film is preferably flexible, meaning that it can flex around the cutting die to some extent without rupturing. It is preferably extensible, meaning that it can stretch around the cutting die to some extent without rupturing. Optionally, the first polymer film is resilient, meaning that it will return to its original size/shape to some extent, after it has been/deformed by the cutting die. However, the first polymer film need not fully return to its original size and shape. For example, the first polymer film may remain embossed with the cutting pattern, after the pressing step.

Preferably, the cutting die and the work piece are pressed together using a cutting press (also known as a die cutting machine).

After cutting the work piece, a portion of the first polymer film may project through the work piece along a contour where the work piece has been cut.

Preferably, the first polymer film is not cut. The first polymer film may stretch, flex, and/or otherwise deform around the cutting die without being punctured, in the process of cutting the work piece.

The method may further comprise, after cutting the work piece, releasing the patterned work piece from the first polymer film.

Releasing may comprise peeling the work piece and the first polymer film apart.

After cutting, the patterned work piece optionally comprises at least one aperture, surrounded by material of the work piece.

That is, the cutting pattern may include at least one cut that forms a closed contour within the boundaries of the work piece. Cutting along this closed contour completely separates one portion of the work piece from another creating an aperture in the work piece. Optionally, the cutting pattern may include a plurality of closed contours.

Preferably the work piece consists of a single contiguous piece of material after cutting. There may be many pieces of waste material (offcuts).

The method may also comprise: providing a second polymer film on the opposite side of the work piece to the first polymer film; and pressing the first polymer film and the second polymer film together, with the work piece between them.

In this case, the work piece is sandwiched between two polymer films. This has been found to further assist in releasing the work piece after cutting. The use of two polymer films may result in better isolation of the portions of the work piece on opposing sides of a cut. It may also make it easier or tidier to release the work piece from the die and offcuts, after cutting.

Preferably, the step of pressing the first polymer film and the second polymer film together happens in the same step as pressing the cutting die and the work piece together.

The second polymer film is preferably flexible, meaning that it can flex around the cutting die to some extent without rupturing. It is preferably extensible, meaning that it can stretch around the cutting die to some extent without rupturing. Optionally, the second polymer film is resilient, meaning that it will return to its original size/shape to some extent, after it has been deformed by the cutting die. However, the second polymer film need not fully return to its original size and shape. For example, the second polymer film may remain embossed with the cutting pattern, after the pressing step.

The first polymer film and the second polymer film may be bonded or become embedded in one another during the step of pressing them together.

For example, a cold weld may be formed between the two films. Preferably, the bonding or embedding is releasable. Thus, the films may be lightly bonded together.

The first polymer film and the second polymer film preferably cooperate to encapsulate a discrete portion of the material of work piece, as a result of the bonding or embedding.

That is, the first polymer film and the second polymer film may be bonded together or embedded along a closed contour, such that they completely enclose a portion of the material of the work piece. This portion may be an offcut (waste) portion, to be cut out of the work piece. When the patterned work piece is subsequently released from the two films, the offcuts may be retained by one or other of the two films.

The first polymer film and the second polymer film may have substantially identical compositions.

Using identical polymer films may help a cold weld to be formed between the two films, along the cutting contours, during the cutting process.

The first polymer film and the second polymer film may both be provided by a single folded sheet of polymer material

The first polymer film and the second polymer film may cooperate to form a pocket or envelope around the work piece.

The pocket or envelope may be closed on two or three sides. This may make it easier and tidier to collect the waste material (offcuts) when releasing the work piece from the first and second polymer films—for example, by shaking the patterned work piece inside the pocket or envelope.

Optionally, at least one and preferably each of the first polymer film and the second polymer film consists of a uniform sheet of homogenous material.

In this case, the (or each) polymer film is not a composite or laminate.

Optionally, at least one and preferably each of the first polymer film and the second polymer film consists of a laminate formed of at least two layers, more preferably at least three layers.

Each layer may be homogeneous and all of the layers may have the same composition. Alternatively, the layers may have different compositions. For example, it is possible to co-extrude films of different types and laminate them together.

Preferably, one or both of the films is transparent.

Optionally, one surface of the work piece contacts one surface of the first polymer film and the cutting die contacts the other surface of the first polymer film.

(Each of the work piece, the first polymer film, and the second polymer film has two surfaces.) That is, the first polymer film is directly between the cutting die and work piece, without any intermediate layers to separate them. The front of the work piece faces and contacts the first polymer film.

In other embodiments, a third polymer film may be provided between the work piece and the cutting die. The third polymer film may be adjacent to the first polymer film in the layer structure. The third polymer film may be joined to the first polymer film, to form a laminate. The third polymer film may be the same as or different from the first polymer film.

Optionally, one surface of the work piece contacts one surface of the second polymer film.

In this case, there is no intermediate layer separating the work piece from the second polymer film. In particular, the back of the work piece is directly facing and contacting the second polymer film.

In some embodiments, a fourth polymer film may be provided in addition to the second polymer film, on the same side of the work piece as the second polymer film (that is, the opposite side to the die and the first polymer film. The fourth polymer film may be adjacent to the second polymer film in the layer structure. The fourth polymer film may be joined to the second polymer film to form a laminate. The fourth polymer film may be the same as or different from the second polymer film.

At least one and preferably each of the first polymer film and the second polymer film may be one of: a cast film; and a blown film.

It is believed that non-oriented film may be able to stretch to a greater extent without breaking (compared with oriented film) and may therefore be better suited for use in the present method. Both blown and cast films can be non-oriented. Preferably the film is not stretched in the manufacturing process. Uniaxial or biaxial stretching is common in some manufacturing processes for polypropylene films. However, it is believed that such stretching could reduce the suitability of the film for the present method.

At least one and preferably each of the first polymer film and the second polymer film may comprise at least one of: polypropylene; polyvinylchloride; polyethylene; polyethylene tetraphthalate; a polyamide, such as nylon; acrylic; polyester; polystyrene; and polyacetate. Linear Low-Density Polyethylene (LLDPE) may be preferred among other types of polyethylene.

Preferably, at least one and possibly each of the first polymer film and the second polymer film comprises at least 50% by weight of these listed polymers. More preferably, said film comprises at least 90%, still more preferably 99%, by weight of the listed polymers.

In some embodiments, the respective polymer film comprises at least 50% by weight of one of the listed polymers. More preferably, said film comprises at least 90%, still more preferably 99%, by weight of this specific polymer.

In some embodiments, at least one or each of the films may comprise two or more of the listed polymers. In some embodiments, at least one film or each film may comprise a mixture (polymer blend) or a copolymer. For example, at least one film or each film may comprise a copolymer comprising polypropylene, such as a polypropylene-polyethylene copolymer. The copolymer may comprise 50% by weight of the film, more preferably 90%, still more preferably 99%.

In some embodiments, either or each of the first polymer film and the second polymer film may be a laminate comprising at least one of the polymers listed above.

Nylon can be laminated, either with other layers of the same composition or with other layers of different composition.

At least one and preferably each of the first polymer film and the second polymer film may be formed of silicone rubber.

Optionally, at least one and preferably each of the first polymer film and the second polymer film has a substantially uniform thickness not greater than 500 μm.

In some embodiments multiple layers of polymer film may be provided between the work piece and the cutting die. In this case, the total thickness of these multiple layers combined is preferably not greater than 500 μm. The same can apply when multiple layers of polymer film are provided at the opposite side of the work piece to the cutting die.

Optionally, at least one and preferably each of the first polymer film and the second polymer film has a substantially uniform thickness not greater than 150 μm.

In some embodiments multiple layers of polymer film may be provided between the work piece and the cutting die. In this case, the total thickness of these multiple layers combined is preferably not greater than 150 μm. The same can apply when multiple layers of polymer film are provided at the opposite side of the work piece to the cutting die.

Optionally, at least one and preferably each of the first polymer film and the second polymer film is made of cast polypropylene with a substantially uniform thickness in the range 20 μm to 200 μm.

Preferably, the thickness may be in the range 80 μm to 120 μm.

More preferably, the (or each) polymer film is made of cast, non-oriented polypropylene with a substantially uniform thickness in the range 90 μm to 110 μm, still more preferably 95 μm to 105 μm, yet more preferably about 100 μm.

Instead of a single layer of film, two or more separate layers of film may be provided, which have a desired combined thickness. Preferably this combined thickness is about 100 μm. For example, instead of a single 100 μm film two films each having a thickness of about 50 μm could be provided. If the desired combined thickness was about 90 μm, three layers each having a thickness of 30 μm could be provided.

Optionally, at least one and preferably each of the first polymer film and the second polymer film has an area in the range 300 cm² to 1300 cm².

The cutting die will typically have a similar area to the work piece.

Optionally, at least one and preferably each of the first polymer film and the second polymer film is rectangular with at least one side in the range 140 mm to 300 mm.

The cutting die will typically have similar dimensions to the work piece.

The work piece may comprise at least one of: paper; card; a fibrous web; and a fabric.

The work piece may comprise a foodstuff.

When the work piece comprises a foodstuff, the first polymer film (and optionally second polymer film) may help to isolate the work piece from other parts of the cutting equipment. This may be desirable for reasons of cleanliness and/or food hygiene.

Preferably, the foodstuff is an edible paper.

The work piece may comprise at least one of: an edible sugar sheet; an icing sheet; a frosting sheet; rice paper; and wafer paper.

Edible sugar sheets are sometimes also referred to as sugar paper.

The cutting die preferably comprises a metal.

The cutting die and the work piece may be pressed together by feeding them between two rollers of a cutting press, or between a roller and another member such as a tray or plate. In some embodiments the cutting die may be wrapped around one of the rollers or may be part of one of the rollers.

According to a further aspect of the invention, there in provided a laminate comprising:

a first polymer film; and

a work piece,

wherein the work piece has at least one incision in it and the polymer film is embossed such that it extends through the work piece at the location of the incision.

The laminate may further comprise a second polymer film on the opposite side of the work piece to the first polymer film, wherein the first and second polymer films meet at the location of the incision.

It will be understood that the preferred features discussed above in the context of the method are also applicable to the laminate.

According to another aspect of the invention, there is provided a kit of parts for die cutting, comprising: a polymer film for placing between a cutting die and a work piece, and any one of, or any combination of two or more of: a cutting press; a cutting die; and a work piece to be cut.

A cutting press is sometimes also referred to as a “die cutting machine”, particularly in the context of domestic craft die cutting. The cutting press preferably has at least one roller, more preferably at least two rollers for pressing the cutting die and the work piece together.

It will be understood that the preferred features discussed above in the context of the method are also applicable to this kit of parts.

Also provided is a method of die cutting, a laminate obtainable by die cutting, or a kit of parts for die cutting, substantially as described herein with reference to the accompanying drawings.

Also disclosed is a method of cutting, comprising:

providing a cutting edge;

providing a work piece to be cut;

providing a first polymer film between the cutting edge and the work piece; and

pressing the cutting edge and the work piece together, with the first polymer film between them, to cut the work piece.

This method may be used with cutting methods other than die cutting.

### BRIEF DESCRIPTION OF THE DRAWINGS

The invention will now be described by way of example with reference to the accompanying drawings, in which:

FIG. 1 is a schematic drawing showing a die cutting process according to an embodiment of the invention;

FIG. 2 is a schematic drawing illustrating a close-up cross section of the work piece during the die cutting process, according to an embodiment; and

FIG. 3 is a schematic drawing showing a die cutting process according to another embodiment.

It should be noted that these figures are diagrammatic and not drawn to scale. Relative dimensions and proportions of parts of these figures have been shown exaggerated or reduced in size, for the sake of clarity and convenience in the drawings.

### DETAILED DESCRIPTION

Conventional die cutting presses (also known as die cutting machines) for use in arts and crafts activities by hobbyists are well known in the art. In general, die cutting relies on the application of pressure to press a cutting die into a work piece, to cut the work piece. In a typical die cutting machine for domestic craft use, the pressure is applied by means of a pair of counter-rotating rollers. An actuating handle is coupled to at least one of the rollers and the user turns the handle to operate the press. The die and work piece are inserted between the rollers and, as the rollers turn, the die and work piece are compressed together between them. The general construction and operation of conventional die cutting machines will be well known to those skilled in the art and will not be described in further detail here.

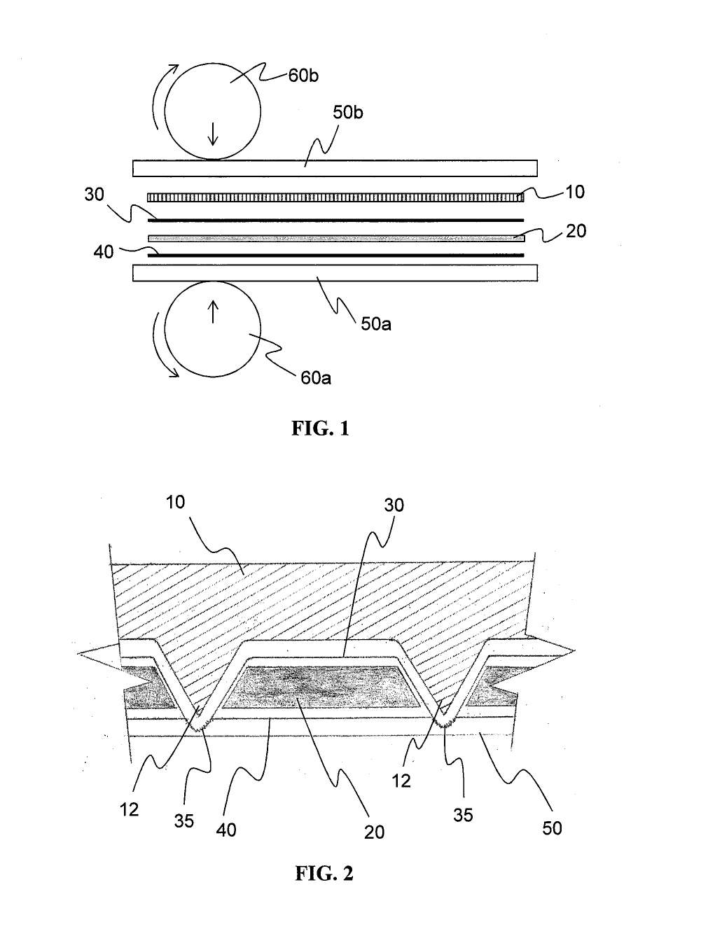

FIG. 1 is a schematic diagram illustrating a method according to one embodiment of the present invention. FIG. 1 illustrates schematically a sandwich of materials being passed between the rollers of a cutting press. This exemplary cutting press operates according to conventional principles—and indeed, the method of this embodiment may be implemented with the assistance of an existing cutting press.

A cutting die 10 is provided. This can be a conventional metal die for cutting paper or card. A work piece 20 is also provided. This can be a conventional paper or cardboard work piece, such as those that are commonly used by hobbyists for making greeting cards.

A first polymer film 30 is provided between the cutting die 10 and the work piece 20. Optionally, a second polymer film 40 is provided at the opposite side of the work piece to the first polymer film 30. In this embodiment, the second polymer film 40 is present and therefore the work piece 20 is sandwiched between the first and second polymer films 30, 40. There are no other layers between those mentioned. Thus, the cutting surface of the die 10 faces and is in contact with the upper surface of the first polymer film 30; the lower surface of the first polymer film 30 faces and is in contact with the upper surface of the work piece 20; and the lower surface of the work piece 20 faces and is in contact with the upper surface of the second polymer film 40.

It is preferred that the first and second polymer films 30, 40 are the same type of film. Indeed, in some embodiments, the first and second polymer films 30, 40 may be provided by a single sheet of polymer film that has been folded. Cast, non-oriented polypropylene with a total thickness of approximately 100 μm is a preferred polymer film. Each polymer film has substantially uniform thickness throughout. To manufacture this film, a melt is extruded in flat layers.

To perform die cutting, the die 10, first polymer film 30, work piece 20, and second polymer film 40 are sandwiched between two cutting pads 50. Cutting pads 50 are also used with conventional die cutting machines. They help to apply pressure evenly to the die and work piece and help to prevent damage to either the die or the work piece (either of which may be fragile). Each cutting pad 50 may comprise a relatively rigid plastic sheet. (That is, the cutting pad is typically stiffer than the die or work piece.) As illustrated in FIG. 1, a lower cutting pad 50a is provided below the second polymer film 40 and an upper cutting pad 50b is provided on top of the die 10. The upper surface of the lower cutting pad 50a faces and is in contact with the lower surface of the second polymer film 40. The lower surface of the upper cutting pad 50b faces and is in contact with the upper surface of the cutting die 10.

In order to cut the work piece 20, the cutting pads 50 and the other components sandwiched between them are inserted between lower compression roller 60a and upper compression roller 60b. The rollers 60 apply a compressive force on the cutting pads 50 in the direction of the straight arrows. The rollers are rotated in the direction of the curved arrows, and the cutting pads 50 roll between the rollers from right to left as illustrated in FIG. 1. The compressive force applied by the rollers 60 presses the cutting die 10 into the work piece 20, to cut the work piece 20.

The result of this process is illustrated in greater detail in FIG. 2. This drawing shows schematically a close up cross section of the components after they have passed through the cutting press. The cutting edges 12 of the cutting die 10 have cut through the work piece 20. The first polymer film 30 has been deformed by the applied pressure to follow the contours of the cutting surface of the cutting die. However, the first polymer film 30 has not been punctured or perforated. It is believed that this is possible due to the flexibility and extensibility of the first polymer film, in comparison with the work piece. In particular, the first polymer film is typically more extensible than a paper or cardboard work piece. The cutting edges 12 of the die 10 can puncture the work piece 20 without necessarily rupturing the first polymer film 30. Note that it is not essential that no rupturing of the first polymer film 30 occurs. Some rupturing can be tolerated. However, it is believed that the less the first polymer film ruptures, the more effective the process will be. Whether or not it is ruptured, the first polymer film 30 may be embossed with the pattern of the cutting edges 12—that is, the first polymer film 30 may be deformed inelastically during the cutting process. As can be seen from FIG. 2, portions of the work piece 20 lying either side of a cutting edge 12 are separated from one another by the first polymer film 30, after cutting.

It is believed that the presence of the first polymer film 30 makes it easier to release the work piece 20 from the die 10 after cutting. It is also believed that the first polymer film 30 helps to isolate the portions of the work piece from one another at the cutting edges 12. It is believed that this makes the cutting more effective and helps the desired patterned work piece to be separated more easily from the unwanted offcut portions after the work piece is removed from the cutting press.

As can also be seen in FIG. 2, the first polymer film 30 comes into contact with the second polymer film 40 at junctions 35 defined by the pattern of cutting edges 12. That is, the pressure applied during the die cutting process pushes the first polymer film 30 through the work piece 20 and into contact with the second polymer film 40. The two polymer films may be bonded together and/or be embedded in one another at the junction regions 35. For example, a cold weld may be formed between the two polymer films at these locations. Where the cutting edge 12 defines a closed contour, a portion of the work piece 20 will be completely isolated from the remainder of the work piece and this portion will be completely encapsulated between the two polymer films. That is, the first polymer film 30 and the second polymer film 40 cooperate to encapsulate an isolated portion of work piece 20. The encapsulated portion of the work piece may be an unwanted, offcut portion. Thus, the desired patterned work piece may have an aperture corresponding to the encapsulated offcut which has been cut from it.

In the embodiment illustrated in FIG. 2, the second polymer film 40 has also been embossed with the pattern defined by the cutting edges 12. However, this embossing is shallower than the embossing of the first polymer film 30.

The result of the cutting process is a laminate comprising the first polymer film 30 and the work piece 20. The work piece has been cut and the first polymer film is embossed such that it extends through the work piece at the location of this cut. In the embodiment pictured, the laminate further comprises the second polymer film 40, at the opposite side of the work piece 20 to the first polymer film 30. The two polymer films meet and engage one another at the location of the cut.

The properties of the first and second polymer films 30, 40 can be chosen according to the intended task. The thickness of the polymer films may depend to some extent on the thickness of the work piece to be cut; the depth of the cutting edge of the die; and/or the pressure applied during the cutting process. In addition to thickness, the physical strength or toughness of the material of the work piece may also be relevant. In general, for a work piece made of thicker material, the cutting edge 12 of the die 10 may be deeper (the vertical dimension in FIG. 2) and/or the first and second polymer films 30, 40 may be thinner. If the film is too thin, it may be too fragile to work correctly and may be ruptured during the cutting process (which should preferably be avoided). On the other hand, if the film is too thick, it may be too inflexible to work correctly and may hinder effective cutting of the work piece 20. Based on these principles, suitable polymer films can be selected for a variety of tasks. However, for cutting paper and cardboard, it has been found that non-oriented, cast polypropylene, with a total thickness of approximately 100 μm is generally suitable. One such film is marketed by Eurocast Sp. z o.o., of Strzebielino, Poland, under the name “CASTFOL PP BS”.

The components needed to implement an embodiment of the present invention may be supplied conveniently in the form of a kit of parts. Such a kit would include one or more sheets of polymer film for placing between a cutting die and a work piece, together with other components or apparatus. For example, according to one embodiment, polymer film is provided in a kit with a cutting press. In another embodiment, polymer film is provided in a kit with a cutting die. In still another embodiment, polymer film is provided in a kit with a work piece to be cut. Of course, as those skilled in the art will understand, polymer film can also be provided in a kit which includes any two or more of the additional components and apparatus mentioned above.

After the cutting step—that is, after the die 10 and work piece 20 have been rolled between the rollers 60, the patterned work piece 20 is released from the first and second polymer films 30, 40. Firstly, the laminate comprising the two films 30, 40 with the work piece 20 sandwiched between them is peeled apart from the cutting die 10. Next, the second polymer film 40 is peeled away from the work piece 20 and first polymer film 30. Then, the work piece 20 is peeled apart from the first polymer film 30. Preferably, the unwanted, offcut portions of material can remain adhered to either the first polymer film 30 or the second polymer film 40 after the patterned work piece 20 is released. This can avoid the need to detach many individual, small, offcut portions from the patterned work piece, by hand. Thus, the hobbyist can produce a finished patterned work piece faster and without the labour-intensive procedure performed by hobbyists in the past, of pushing out many small offcut portions with a stylus. When the offcut portions are retained by the polymer films 30, 40, the process according to an embodiment of the present invention can also be much cleaner and tidier than the prior art procedure.

The polymer films 30, 40 can generally be used for die cutting more than once. That is, after being used in the process of cutting one work piece, they can be reused in the process of cutting another work piece. However, if the polymer films are reused multiple times, they will eventually become weakened and more likely to rupture. Hence, it is desirable to replace the polymer films after a small number of uses. In the present example, the 100 μm polypropylene films are preferably replaced after approximately ten uses. This will depend on the thickness and toughness of the work piece, as well as the characteristics of the film. Note that it is not essential to replace the film as soon as it has ruptured. The film may continue to provide benefit after it has ruptured in some places.

Many variations to the embodiments described above are possible.

In an alternative implementation of the method, the steps of releasing the work piece could be performed in a different order. For example, the first polymer film 30 could be removed from the work piece 20 and second polymer film 40, followed by removal of the second polymer film from the work piece.

The polymer films could be blown film instead of the cast film mentioned above. Also, the films are not necessarily formed of polypropylene. For example, the films could be formed from polyvinylchloride, polyethylene, polyethylene tetraphthalate; a polyamide; polyester; polystyrene; acrylic, or polyacetate (among others). For these films, thicknesses of up to 150 μm may be appropriate. In other embodiments, the polymer films are formed of silicone rubber. For silicone films, thicknesses of up to 500 μm may be suitable.

As mentioned previously above, the first and second polymer films 30, 40 may be provided by a single folded film. One fold would mean that the films could be peeled apart after the die cutting step and remain attached to one another along the folded edge. This may help with the retention of offcut material, because offcut portions that are accidentally released from where they are encapsulated in the polymer films may still be caught when they fall into the fold. Alternatively or in addition to a fold, the first polymer film and second polymer film may be joined together more extensively. For example, if the films are rectangular, they may be joined together along three sides of the rectangle. This forms a pocket around the work piece. The work piece may then be released via the fourth, open edge of the rectangle, with the offcut portions of material remaining inside the pocket. In a further example, the polymer films may be joined together along all four sides of the rectangle, to completely envelope the work piece. In this case, the envelope could be agitated to release the work piece and/or offcuts (for example by shaking, tapping, or bending). Then, the envelope formed by the polymer film or films could be opened by cutting or tearing along one edge, to release the patterned work piece.

In the embodiments discussed above, the work piece was paper or cardboard. In other embodiments, the work piece may comprise a fibrous web or a fabric. In still other embodiments, the work piece may comprise a foodstuff. For example, baking and cake decorating are also popular craft activities. Similar to the process of die cutting decorations for greeting cards, it is possible to die cut decorations for baked goods. In this case, the work piece may comprise—for example—an edible sugar sheet, a sheet of rice paper, or a sheet of wafer paper. When cutting an edible work piece, the use of the polymer films may have the additional benefit that the food stuff is isolated from the other parts used in the cutting process. In one example, the first and second polymer films are disposable. Preferably, they are food-safe. The use of disposable and/or food-safe polymer films may be desirable from the perspective of food safety and avoiding contamination. It is believed that polypropylene can be a suitable food-safe material for the polymer films in the context of cutting foodstuffs. Other components used in the die cutting process may be difficult to clean or not food-safe. When the work piece is a foodstuff, it may be preferable for the polymer film (or films) not to rupture, and therefore for the film (or films) to be replaced before they rupture. The films may be used only once and replaced after this single use. This can help to ensure good food hygiene and help to avoid contamination from other components used in the die cutting process.

As mentioned earlier above, the use of the second polymer film 40 is optional, in general. If the second polymer film is not used, offcut portions of the work piece 20 are not completely encapsulated between two films. However, the first polymer film still helps to isolate portions of the work piece on either side of a cutting edge 12, and can thereby assist in the release of the work piece from the cutting die 10 and can help to retain offcuts when the patterned work piece is released from the first polymer film 30. An advantage of such embodiments may be the reduction in the amount of polymer film that is needed for the process. In an embodiment in which the second polymer film 40 is absent, the upper surface of the lower cutting pad 50a may face and be in contact with the lower surface of the work piece 20.

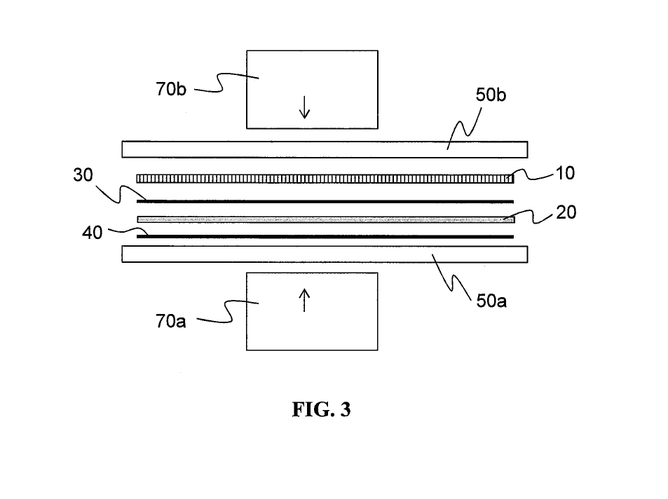

As will be apparent to those skilled in the art, it is not essential to use a cutting press having rollers, of the kind illustrated in FIG. 1. FIG. 3 illustrates an alternative embodiment in which the cutting pads 50 and the sandwich of other layers are compressed by pressing blocks or jaws 70. In this embodiment, there is no lateral motion of the cutting pads 50. A lower jaw 70a presses upward, in the direction of the arrow, exerting a force on the lower cutting pad 50a. An upper jaw 70b presses downwards on the upper cutting pad 50b. Note that this embodiment may require more rigid cutting pads 50, to ensure an even application of pressure over the entire die 10 and work piece 20.

In other embodiments, rollers may be used, but the cutting die may be wrapped around one of the rollers, or may be provided integrally with the roller.

In some embodiments, the cutting press may have one roller and one other member for pressing the work piece and the cutting die together. The other member may be a tray or plate, which preferably presents a substantially planar surface on its side facing the roller. Turning the roller urges the work piece through a gap between the plate and the roller. The work piece slides relative to the plate, under the force imparted by the roller. In this embodiment, like other embodiments using one or more rollers, the cutting die may optionally be integrated with the roller—for example, wrapped around the roller or formed integrally in the surface of the roller.

Other variations to the disclosed embodiments can be understood and effected by those skilled in the art.

1. A method of die cutting, comprising:
providing a cutting die;
providing a work piece to be cut;
providing a first polymer film between the cutting-die and the work piece; and
pressing the cutting die and the work piece together, with the first polymer film between them, to cut the work piece.

2. The method of claim 1 wherein, after cutting the work piece, a portion of the first polymer film projects through the work piece along a contour where the work piece has been cut.

3. The method of claim 1 further comprising, after cutting the work piece, releasing the cut work piece from the first polymer film.

4. The method of claim 1 wherein, after cutting, the cut work piece comprises at least one aperture, surrounded by material of the desired patterned work piece.

5. The method of claim 1, comprising:
providing a second polymer film on the opposite side of the work piece to the first polymer film; and
pressing the first polymer film and the second polymer film together, with the work piece between them.

6. The method of claim 5, wherein the first polymer film and the second polymer film are bonded or become embedded in one another during the step of pressing them together.

7. The method of claim 6, wherein the first polymer film and the second polymer film cooperate to encapsulate a discrete portion of the material of work piece, as a result of the bonding or embedding.

8. The method of claim 5, wherein the first polymer film and the second polymer film have substantially identical compositions.

9. The method of claim 8, wherein the first polymer film and the second polymer film are both provided by a single folded sheet of polymer material

10. The method of claim 5, wherein the first polymer film and the second polymer film cooperate to form a pocket or envelope around the work piece.

11. The method of claim 1, wherein at least one and preferably each of the first polymer film and the second polymer film consists of a uniform sheet of homogenous material.

12. The method of claim 1, wherein one surface of the work piece contacts one surface of the first polymer film and the cutting die contacts the other surface of the first polymer film.

13. The method of claim 1, wherein one surface of the work piece contacts one surface of the second polymer film.

14. The method of claim 1, wherein at least one and preferably each of the first polymer film and the second polymer film is one of:
a cast polypropylene film; and
a blown polypropylene film.

15. The method of claim 14, wherein at least one and preferably each of the first polymer film and the second polymer film is made of cast polypropylene with a substantially uniform thickness in the range 20 μm to 200 μm.

16. The method of claim 1, wherein the work piece comprises at least one of: paper; card; a fibrous web; a fabric; and a foodstuff, the foodstuff preferably comprising at least one of: an edible sugar sheet; an icing sheet; a frosting sheet; rice paper; and wafer paper.

17. The method of claim 1, wherein the cutting die and the work piece are pressed together by feeding them between at least one roller and at least one other member of a cutting press.

18. A laminate comprising:
a first polymer film; and
a work piece,
wherein the work piece has at least one incision in it and the polymer film is embossed such that it extends through the work piece at the location of the incision.

19. The laminate of claim 18, further comprising a second polymer film on the opposite side of the work piece to the first polymer film, wherein the first and second polymer films meet at the location of the incision.

20. A kit of parts for die cutting, comprising:
a polymer film for placing between a cutting die and a work piece, and
any one of, or any combination of two or more of:
a cutting press;
a cutting die; and
a work piece to be cut.
